(19) United States
(12) Patent Application Publication
(10) Pub. No.: US 2019/0095937 A1
(43) Pub. Date: Mar. 28, 2019

(54) PURCHASING POWER PARITY SYSTEMS AND METHODS

(71) Applicant: MasterCard International Incorporated, Purchase, NY (US)

(72) Inventors: Peter Groarke, Dublin (IE); Ahmed Hosny, Dublin (IE)

(21) Appl. No.: 15/713,194

(22) Filed: Sep. 22, 2017

(51) Int. Cl. G06Q 30/02; G06Q 10/08

(52) U.S. Cl. CPC G06Q 30/0205; G06Q 10/087

(57) ABSTRACT

A parity rating (PR) computing device for calculating a purchasing power parity (PPP) rating is disclosed. The PR computing device includes a processor in communication with a memory. The processor is configured to store electronic transaction data including a purchase amount, a purchase location, and item level data, the electronic transaction data retrieved from a payment network that processes electronic transaction data. The processor is further configured to receive a request for a PPP rating that includes a first geographic region and a second geographic region and an input time period. The processor is further configured to retrieve first item data for the first geographic region during the input time period, and second item data for the second geographic region during the input time period, compare the first item data to the second item data, and calculate the PPP rating for the first geographic region based on the comparison.

### BACKGROUND OF THE DISCLOSURE

The field of the disclosure relates generally to purchasing power parity (PPP) services, and more specifically to methods and systems for generating a PPP rating using data from payment transactions processed over a payment network.

Purchasing Power Parity (PPP) measures the purchasing power between different countries' currencies through a market “basket of goods” approach. In theory, a PPP rating is equivalent or on par for two currencies if, for example, taking into account the exchange rate, a market basket of goods is priced the same in both countries. PPP ratings are generally valuable, for instance, in estimating exchange rates and predicting currency price movements. Unfortunately, current PPP rating calculations suffer from the difficulties of finding multiple like-for-like products to include in the market basket of goods to accurately compare the purchasing power between countries. Additionally, PPP ratings are typically determined on a monthly basis and do not accommodate for price fluctuations that can occur more frequently. Consequently, resolving a sample basket of goods that is both representative and sufficiently extensive is a challenge, particularly over shorter time periods or, more particularly, in real-time.

Some traditional PPP rating determinations are based on non-identical baskets of goods. For instance, if a representative basket of goods for the United States includes bread, while a representative basket of goods for China includes rice, the calculated PPP rating values are less indicative of the actual purchasing power between the two countries. When the basket of goods is not commonly representative to both countries/currencies, fewer exact product comparisons can be made. In some known systems that generate a PPP rating, the rating is based on a price index for a single product because a true like-for-like product comparison cannot be ensured. This single product comparison fails to provide accurate PPP ratings, which should correspond to general price levels based on extensive comparison of various goods and services.

Accordingly, there is a need for a system and process that determines of PPP ratings that properly compares price level differences in a timely manner, and more accurately characterizes purchasing power between currencies.

### BRIEF DESCRIPTION OF THE DISCLOSURE

In one aspect, a parity rating (PR) computing device for calculating a purchasing power parity (PPP) rating is provided. The PR computing device includes at least one processor in communication with at least one memory. The at least one processor is configured to store, within the at least one memory, electronic transaction data including a purchase amount, a purchase location, and item level data, wherein the electronic transaction data is retrieved from a payment network that processes electronic transaction data. The at least one processor is further configured to receive, from an input user device, a request for a PPP rating that includes a first geographic region and a second geographic region. The processor is further configured to receive an input time period from the input user device. The processor is further configured to retrieve, from the electronic transaction data stored within the at least one memory, first item data for the first geographic region during the input time period, and second item data for the second geographic region during the input time period. The processor is further configured to compare the first item data to the second item data, and calculate the PPP rating for the first geographic region based on the comparison.

In another aspect, a computer-implemented purchasing power parity (PPP) rating system for calculating a PPP rating is provided. The PPP rating system includes a parity rating (PR) computing device for calculating a purchasing PPP rating. The PR computing device includes at least one processor in communication with at least one memory. The at least one processor is configured to store, within the at least one memory, electronic transaction data including a purchase amount, a purchase location, and item level data, wherein the electronic transaction data is retrieved from a payment network that processes electronic transaction data. The at least one processor is further configured to receive, from an input user device, a request for a PPP rating that includes a first geographic region and a second geographic region. The processor is further configured to receive an input time period from the input user device. The processor is further configured to retrieve, from the electronic transaction data stored within the at least one memory, first item data for the first geographic region during the input time period, and second item data for the second geographic region during the input time period. The processor is further configured to compare the first item data to the second item data, and calculate the PPP rating for the first geographic region based on the comparison.

In yet another aspect, a computer-implemented method for calculating a purchasing power parity (PPP) rating is provided. The method is implemented using a parity rating (PR) computing device including a processor in communication with a memory. The method includes storing, within the memory, electronic transaction data including a purchase amount, a purchase location, and item level data, wherein the electronic transaction data is retrieved from a payment network that processes electronic transaction data. The method further includes receiving, from an input user device, a request for a PPP rating that includes a first geographic region and a second geographic region. The method further includes receiving an input time period from the input user device. The method further includes retrieving, from the electronic transaction data stored within the at least one memory, first item data for the first geographic region during the input time period, and second item data for the second geographic region during the input time period. The method further includes comparing the first item data to the second item data, and calculating the PPP rating for the first geographic region based on the comparison.

### BRIEF DESCRIPTION OF THE DRAWINGS

FIG. 1 is a diagram of an example embodiment of a purchasing power parity (PPP) rating system described herein.

FIG. 2 is a box diagram of an example parity rating (PR) computing device used in the PPP rating system described in FIG. 1.

FIG. 3 is a box diagram of the PR computing device including the data elements used to calculate a PPP rating.

FIG. 4 illustrates an example configuration of an input user device used in the PPP rating system shown in FIG. 1.

FIG. 5 illustrates a configuration of a database server used in an alternative embodiment of PPP rating system shown in FIG. 1.

FIG. 6 is a diagram of components of one or more example PR computing devices used in the PPP rating system shown in FIG. 1.

FIG. 7 shows a method for calculating a PPP rating using the PR computing device shown in FIG. 1.

### DETAILED DESCRIPTION OF THE DISCLOSURE

Embodiments of the present disclosure describe methods and systems for computing a purchasing power parity (PPP) rating that utilize improved, direct, and representative source data from a payment network to generate PPP ratings that more exactly indicate purchasing power between countries (e.g., between currencies). For example, in cases where traditional PPP rating calculations rely on price listings that may be reported indirectly by governments of countries that may be incentivized to provide less than accurate price listings, the inherent disadvantages of such unreliable figures are addressed by the present system by using actual transaction price-paid data when determining the PPP rating. The PPP ratings determined herein incorporate granular transaction data (including actual prices paid for identical and/or same category products) based on a selected time range, country or geographic region, and comparison country or geographic region. As described herein, a more robust and reliable PPP rating is generated by comparing the actual purchase price for each matching product between geographic regions over a given time period and across an array of matching products or services for sale.

The PPP rating system described herein is configured to generate extensive, representative PPP rating values in real time. For example, the PPP rating system generates both composite-type and specific-type PPP ratings between designated geographical regions and time periods, and provides the generated PPP rating information via a user-accessible API/service.

The PPP rating system includes a parity rating (PR) computing device for calculating a PPP rating. The PR computing device is a specifically configured computing device that is capable of functioning as described herein, including a dedicated computing device associated solely with the PPP rating system. The PR computing device includes at least one processor in communication with at least one memory.

The at least one processor is configured to store, within the at least one memory, electronic transaction data including a purchase amount, a purchase location, and item level data. The electronic transaction data is retrieved from a first payment network for processing electronic transaction data. The purchase amount is the amount of currency required to purchase the good or service. The purchase location is the geographic region where the purchase took place, such as but not limited to, the merchant store location and/or the location of the point of sale (POS) device.

In the example embodiment, the memory of the PR computing device is a centralized database that is integral to the PR computing device. In alternative embodiments, the database is a separate component and external to the PR computing device. For example, in the alternative embodiment, the database is a separate external server that is configured to communicate with the PR computing device. The memory is accessible to the PR computing device and is configured to store and/or otherwise maintain a variety of information, as described further herein. For example, the database may store item level data, product categories, merchant categories, country codes, transaction data (e.g., time range, base country, comparison country, product identifiers, merchant identifiers, purchase prices, etc.), PPP rating modules, and/or any other information.

The item level data includes an item identifier that uniquely identifies the item, wherein the item includes a good or service. The item identifier identifies at least one of a manufacturer of the item, an item description, a material used to make the item, a size, a color, a packaging number of the item, and a warranty number associated with the item. In some embodiments, the item level data is at least one of stock keeping unit (SKU) data, clearing element data, transaction data, and/or data obtained from a third party using the transaction data. The third party is any entity capable of storing electronic transaction data separate from the payment network described herein.

For example, a specific SKU number may be associated with a specific product or service for sale, such as a specific computer model. The SKU number for the example computer model may have at least one associated characteristic, such as but not limited to computer brand, computer hardware, computer color, computer size, computer packaging, and/or computer serial number. The SKU number or numbers associated with the specific computer model can be used to compare products and/or services with similar associated characteristics. For example, one SKU number may encompass all SONY® brand computers, while another SKU number may encompass only the specific computer model.

In the example embodiment, the PR computing device receives at least a purchase amount, a purchase location, and any other data elements associated from the purchase of a product from the payment network. The PR computing device is further configured to receive matching item level data from the third party entity (e.g., the merchant selling the item, or some other entity with information describing the item(s) purchased) using any suitable communication means. For example, the PR computing device may receive item level data from the third party entity through a web call and/or web service. In alternative embodiments, the transaction data including the item level data is retrieved from the payment network (e.g., item level detail included in the authorization messages).

The at least one processor is further configured to receive, from an input user device, a request for a PPP rating that includes a first geographic region and a second geographic region. The input user device is any device suitable for communication with the PR computing device. For example, the input user device includes, but is not limited to, a mobile device, a cell phone, a tablet, a laptop, a wearable computing device, and/or any other computing device.

In some embodiments, the input user device is configured to maintain a user interface for communication between a user and the PR computing device. The input user device is configured to execute instructions causing display of a software application (“app”) or browser associated with the input and output functionality described herein. In such embodiments, the user may input information to the input user device via an app or a web-browser, as displayed on the user interface. The physical user interface may be integral to the input user device (such a smartphone or tablet) “paired with” or otherwise in communication with the PR computing device, such that the PR computing device causes display of the app or browser as a virtual user interface on the physical user interface of the input user device. In some embodiments, the app is a cloud-based application, such that information associated with the app (e.g., product identifiers and categories, merchant identifiers and categories, time-dependent and region-based transaction data, etc.) is stored remotely and/or in a cloud environment (e.g., not in one centralized database). Moreover, the app is configured to enable access from a plurality of input user device(s) to the PPP rating generation services of the PR computing device, to make discovery of PPP rating values and related information and services, such as real-time tracking services, readily available to the user. In some embodiments, the app may have inter-app integration functionality, such that the PPP rating generation services of the app may be integrated with, for example, real time graphical charting and display services of another application.

In the example embodiment, the user accesses the app or browser via the user interface. The PR computing device causes display of a prompt for the user to enter criteria for a PPP rating request. For example, input criteria for a PPP rating request may include at least the first region and the second region. In some embodiments, the PR computing device causes display of drop-down lists, text entry fields, buttons, other selection or entry fields, and/or combinations thereof for the user to select, set, edit, update, and/or define PPP rating criteria.

The request for a PPP rating is a wireless or wired communication, initiated by a user using the input user device, including a first geographic region and a second geographic region. In some embodiments, more than two geographic regions are included within the request for a multilateral PPP rating calculation.

In the example embodiment, the first and second geographic region are countries. In alternative embodiments, the geographic regions can each be a country, a combination of countries, a portion of a country, etc., or any other suitable geographic area designated to be relevant for PPP rating determination (e.g., a combination of countries utilizing the same currency). For example, the user, using the input user device, may select the United States for the first geographic region, and China for the second geographic region. All relevant transaction data from both geographic regions will be retrieved to calculate a PPP rating, described in detail below. The selection is embedded within the request and communicated with the PR computing device.

The processor is further configured to receive an input time period from the input user device. Responsive to the request, the PR computing device is configured to determine a time range over which to make the PPP rating calculation for the designated regions. In the example embodiment, the input time period, selected by the user, is included within the request as described above. In alternative embodiments, a pre-defined time range or period is included within the request as described below.

In the example embodiment, an input time period includes a time range or period of at least a day, a week, a month, and a year. The range of time associated with the PPP request can be, for example, a past day, a past week, a past month, and/or any relevant or desired range of time such as “real time” up to and including the last day/week/month, etc. In some embodiments, the range of time is set by the user and a selected time range is included in the request. In other embodiments, the request does not include a time range, and as a result the range of time is set by the PR computing device, such as according to a default setting (e.g., the previous 7 days).

For example, the user, using the input user device, may select to retrieve all transaction data for the relevant product for the month of April 2015. Alternatively, the user may select to retrieve all relevant transaction data for the entire year 2016. The selection is embedded within the request and communicated with the PR computing device.

The PR computing device is then configured to retrieve, from the electronic transaction data stored within the at least one memory, a plurality of item data (e.g., first item data) for the first geographic region for the input time period, and a second plurality of item data (e.g., second item data) for the second geographic region for the input time period. Electronic transaction data, as described above, is data associated with the purchase of a product or item (i.e., goods and/or services). The electronic transaction data, herein referred to as transaction data, that is to be retrieved is at least associated with the designated first and second regions and the time range.

In the example embodiment, transaction data is retrieved from the payment network by identifying financial transaction messages (such as from credit and debit transactions) where the region/country code corresponds to one of the regions designated by the request, and where the date/time stamp corresponds to the specified time range. In some embodiments, a country code comprises a POS country code or a merchant country code. For each corresponding financial transaction message that is identified, relevant transaction data is extracted and subsequently stored in the memory of the PPP rating system. Relevant transaction data includes, for example, transaction amount, transaction currency, transaction amount in a settlement currency, transaction date and time, POS country code, merchant country code, and/or product-specific data regarding the purchased product (e.g., a product identifier such as a stock keeping unit (SKU), clearing data element and/or alternative product identifier). The PR computing device is generally configured to detect missing transaction data fields and populate those fields with relevant data obtained from a third party resource, as necessary. For example, when product SKU data is not contained in the financial transaction message, the PR computing device uses other transaction data (such as an alternative product identifier) included in the message to retrieve the specific product SKU data from a third party resource.

The processor is further configured to compare the first item data to the second item data, and calculate the PPP rating for the first geographic region based on the comparison. In the example embodiment, the PR computing device is configured to calculate a PPP rating based at least in part on the retrieved transaction data. In general, the PR computing device is configured to detect the product, merchant, and/or category identifiers common to both the first region and the second region within the retrieved transaction data. With respect to PPP rating accuracy, only a transaction from the first region that has a matching identifier (i.e., product, merchant, and/or category identifier) to a transaction from the second region, and vice versa, is utilized in determination of the PPP rating. In some embodiments, the PPP calculation involves averaging and/or weighting data points (i.e., transaction amounts) for transactions associated with each region, and subsequently comparing the average (or weighted average) between regions to determine a PPP rating. In some embodiments, the PPP calculation involves generating an array of ratios for each transaction match between the selected geographical regions. An average and/or weighted average of the ratios are used to determine the PPP rating. In some embodiments, the transaction data is subject to various statistical data treatment methods such as significance testing, data point weighting, and/or outlier removal. For instance, confidence intervals, standard deviation, etc., may be calculated with respect to reporting strength and/or robustness of each PPP rating calculation.

For example, the PR computing device, responsive to the request for a PPP rating, compares the purchase amounts of a product or products containing similar or matching product, merchant, and/or category identifiers purchased during the requested input time period. The product category ID of the first item data is matched with the product category ID of the second item data. Additionally or alternatively, the product ID of the first item data is matched with the product ID of the second item data. The purchase amounts of the matching data for the time range of the input time period are then compared. The comparison is used to calculate the PPP rating of the selected regions.

In some embodiments, the calculated value is a specific-type PPP rating value which is based on transaction data corresponding to an individual product, an individual merchant, an individual product category, or an individual merchant category. In some embodiments, the request is designated as a specific-type PPP rating request and includes an identifier for the product, merchant, or category that is to be considered in the PPP rating determination. For instance, the request may include a product identifier (e.g., the SKU number for a particular dishwasher), a product category identifier (e.g., GE dishwashers or all dishwashers), a merchant identifier (e.g., Sears), or a merchant category identifier (e.g., dishwasher retailers or kitchen appliance retailers). In determining the specific-type of PPP rating, only transactions from each region having the designated individual identifier (i.e., product, merchant, and/or category identifier) are utilized.

In some embodiments, the calculated value is a composite-type PPP rating value which is based on transaction data for multiple products, merchants, and/or categories. In some embodiments, when the request is designated as a composite-type request, but contains no particular product, merchant, or category identifiers, the PR computing device is configured to calculate a composite-type PPP rating between the first region and the second region across all matching product (i.e., all matching product identifiers). In other embodiments, the request is designated as a composite-type PPP rating request and includes product, merchant, or category identifiers that are to be considered in the PPP rating determination. For instance, the request may designate more than one product category identifier (e.g., toys and games). In determining the composite-type PPP rating, base country transactions must fall under one of the designated identifiers and also have a matching product identifier from the comparison region.

Once the PPP rating has been calculated, the PR computing device is configured to transmit and cause display of the generated PPP rating at least at the input user device from which the request was received. In some embodiments, the generated PPP rating is a composite-type rating based on multiple products, merchants, and/or categories. In other embodiments, the generated PPP rating is a rating that is specified according to an individual product, merchant, product category, or merchant category. In some embodiments, additional information is also transmitted to the user computing device along with the PPP rating. For example, the additional information includes the number of product comparisons made, number of raw data points used for each region, an associated confidence interval for the calculated PPP rating, identifiers for the specific products, merchants, and/or categories used in the calculation, and/or other statistically relevant information that is associated with the generated PPP rating. Further, in some embodiments, the additional information includes continuous time-dependent (e.g., real time or other designated time range) graphical display of generated PPP ratings.

In some embodiments, the transaction data associated including the first item data is retrieved from the request communicated to the PR computing device and the first payment network. The electronic transaction data including the second item data is retrieved from a second payment network for processing electronic transaction data. The first item data from the first payment network is matched and compared to the second item data from the second payment network, and wherein the PPP rating is calculated for the first geographic region based on the comparison. In alternative embodiments, the first item data and the second item data are retrieved from the first payment network.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard input user and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

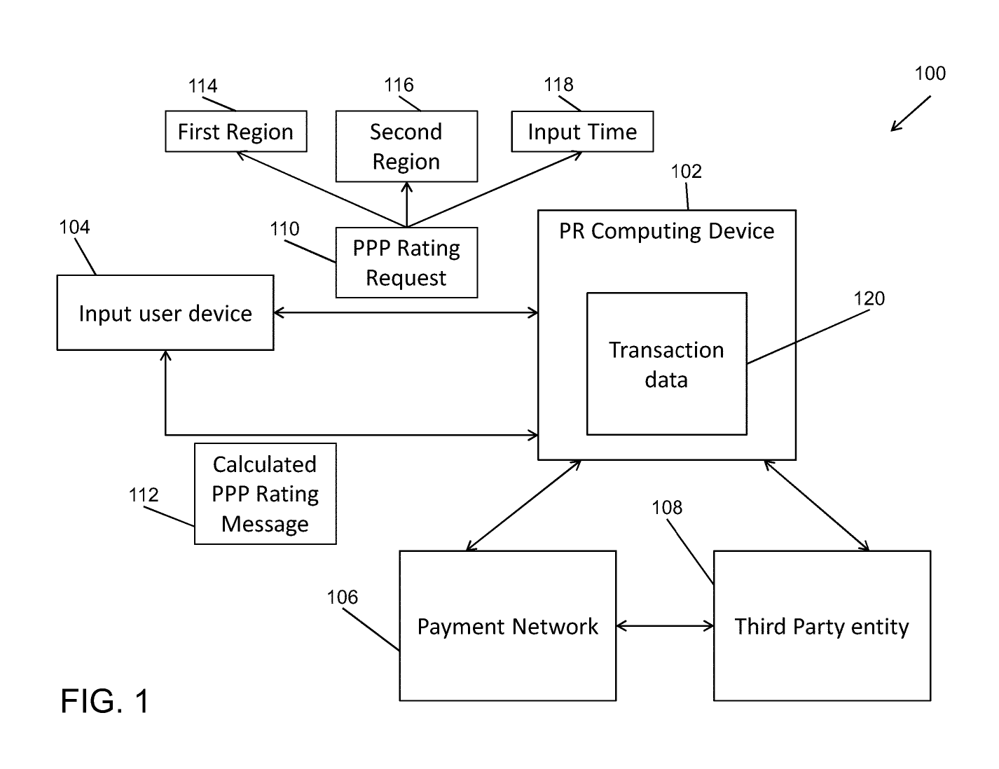

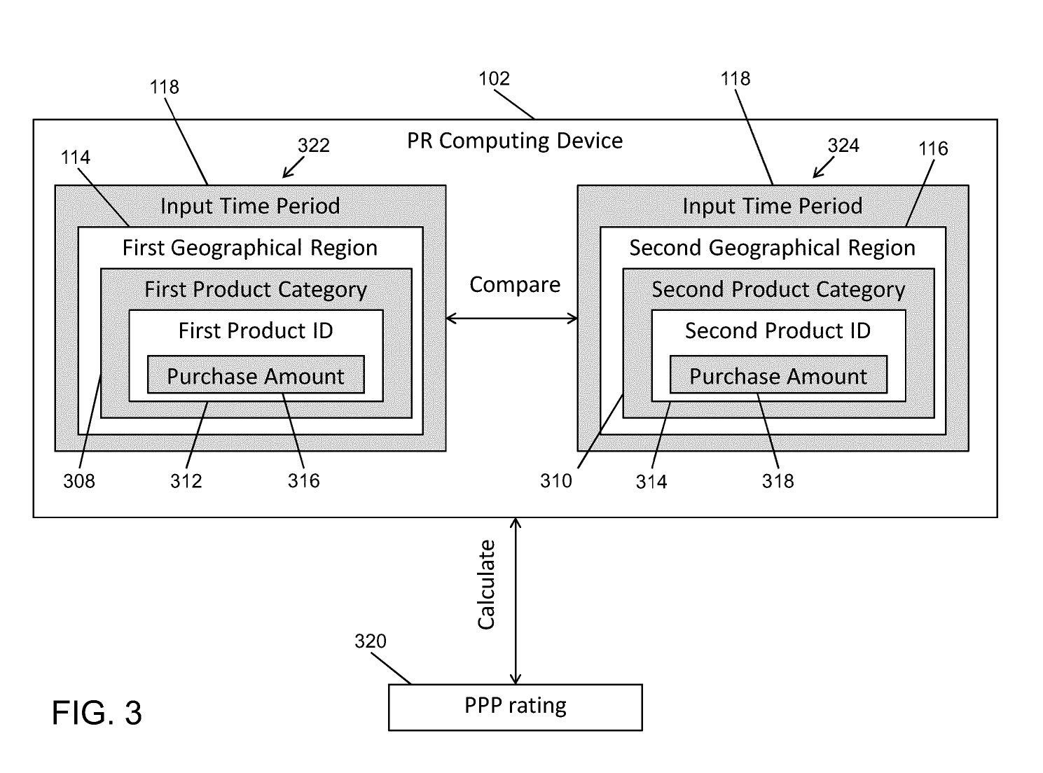

FIG. 1 is a diagram of an example embodiment of a purchasing power parity (PPP) rating system 100 as described herein. PPP rating system 100, as described herein, provides comprehensive, real time PPP rating values and information based on accurate like-for-like product/item comparisons using purchase prices by leveraging actual transaction data processed over a payment network. PPP rating system 100 is configured to generate both composite-type and specific-type PPP ratings 320 (shown in FIG. 3) between designated geographic regions and time periods, and provides the generated PPP rating information via a user-accessible API/service. System 100 includes a parity rating (PR) computing device 102 for calculating PPP ratings 320 (shown below in FIG. 3). PR computing device 102 is configured to communicate with at least one of an input user device 104, a payment network 106, and/or a third party entity 108.

PR computing device 102 is configured to receive a PPP rating request 110 initiated by input user device 104. In the example embodiment, input user device 104 is any device suitable for communication with PR computing device 102, including but not limited to, a mobile device, a cell phone, a tablet, a laptop, a wearable computing device, and/or any other computing device. Request 110 includes, but is not limited to, a first geographic region 114, a second geographic region 116, and or an input time 118. Request 110 is sent from input user device 104 to PR computing device 102 through either a wired or wireless communication. In the example embodiment, as described above, first geographic region 114 and second geographic region 116 are countries.

Request 110 further includes input time 118. Input time 118 includes a time range or period of at least one of a day, a week, a month, and a year. In alternative embodiments, request 110 does not include input time 118, and as a result the range of time is set by PR computing device 102, such as according to a default setting (e.g., the previous 7 days).

PR computing device 102 is further configured to receive and store a plurality of transaction data 120 (described in detail below) from at least one of a payment network 106, such as Mastercard® International Incorporated, and/or a third party entity 108. Third party entity 108 is any entity capable of storing electronic transaction data separate from payment network 106.

PR computing device is further configured to compare the plurality of transaction data 120 between products purchased, during the time period of input time 118, in first geographic region 114 and second geographic region 116. Using the comparison, PR computing device is then configured to calculate the PPP rating 320 (described in detail below). Thus, a more robust and reliable PPP rating 320 is generated that more exactly indicate purchasing power between countries (i.e., between currencies). In some embodiments, PR computing device is configured to embed PPP rating within a PPP rating message 112, wherein PPP rating message 112 is communicated to input user device 104.

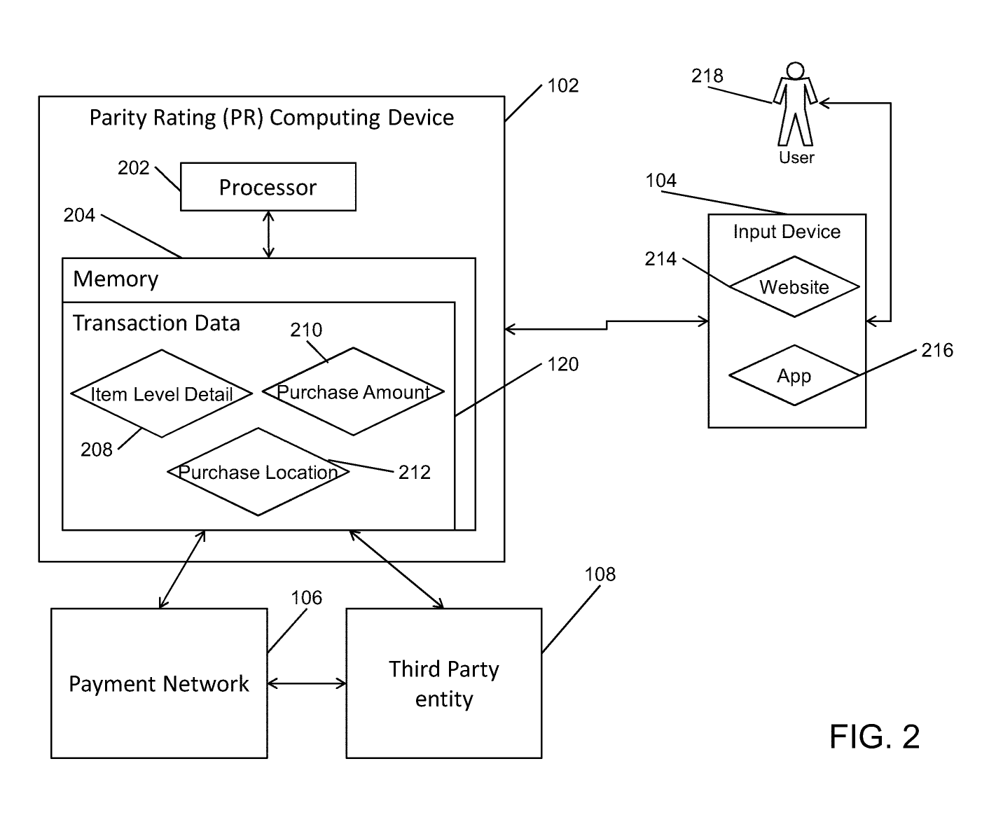

FIG. 2 is a block diagram of an example parity rating (PR) computing device 102 used in the PPP rating system 100 as described in FIG. 1. As described above, PR computing device 102 is a specifically configured computing device that is capable of functioning as described herein, including a dedicated computing device associated solely with PPP rating system 100. PR computing device 102 includes at least one processor 202 in communication with at least one memory 204.

Processor 202 is configured to store, within memory 204, a plurality of electronic transaction data 120. Transaction data 120 includes, but is not limited to, a purchase amount 210, a purchase location 212, and a plurality of item level data 208. Purchase amount 210 is the number of currency required to purchase the item. Purchase location 212 is the geographical region that the purchase of the item took place, such as but not limited to, the merchant store location and/or the location of the point of sale (POS). Item level data 208 includes an item identifier that uniquely identifies the item, wherein the item includes a good or service. The item identifier identifies at least one of a manufacturer of the item, an item description, a material used to make the item, a size, a color, a packaging number of the item, and a warranty number associated with the item. In some embodiments, item level data 208 is at least one of stock keeping unit (SKU) data, clearing element data, and/or data obtained from third party 108 using transaction data 120.

In the example embodiment, PR computing device 102 receives at least purchase amount 210, purchase location 212, and any other data elements associated from the purchase of the item from payment network 106. PR computing device 102 is further configured to receive matching item level data 208 from third party entity 108 using any suitable communication. For example, PR computing device 102 may receive item level data 208 from third party entity 108 through a web call and/or web service. In alternative embodiments, electronic transaction data 120, including item level data 208, is retrieved from payment network 106.

Processor 202 is further configured to receive, from an input user device 104, request 110 (as described in detail above) for PPP rating 320. In the example embodiment, a user 218 initiates request 110 by selecting a prompt on input user device 104 to enter criteria for PPP rating request 110. For example, input criteria for PPP rating request 110 include at least first region 114 and second region 116. In some embodiments, PR computing device 102 causes display of drop-down lists, text entry fields, buttons, other selection or entry fields, and/or combinations thereof for the user to select, set, edit, update, and/or define PPP rating criteria using input user device 104. In some embodiments, request 110 is initiated when user 218, using input user device 104, accesses a website 214 and/or a software application 216 in communication with PR computing device 102.

FIG. 3 is a block diagram of the PR computing device 102 including data elements used to calculate a PPP rating 320. PR computing device 102, using processor 202, is configured to compare a plurality of first item data 322 to a plurality of second item data 324, and calculate PPP rating 320. In the example embodiment, PR computing device 102 is configured to calculate PPP rating 320 based at least in part on the retrieved transaction data 120 (shown in FIG. 1). PR computing device 102 is configured to detect the product, merchant, and/or category identifiers common to both first region 114 and second region 116 within retrieved transaction data 120. To ensure better accuracy of PPP rating 320, only a transaction from first region 114 that has a matching identifier (i.e., product, merchant, and/or category identifier) to a transaction from second region 116, and vice versa, is utilized in determining PPP rating 320. In some embodiments, PPP rating 320 calculation involves averaging and/or weighting data points (i.e., transaction amounts) for transactions associated with each region 114 and 116, and subsequently comparing the average (or weighted average) between regions to determine PPP rating 320. In some embodiments, PPP rating 320 calculation involves generating an array of ratios for each transaction match between the selected geographical regions 114 and 116. An average and/or weighted average of the ratios is used to determine PPP rating 320. In some embodiments, transaction data 120 is subject to various statistical data treatment methods such as significance testing, data point weighting, and/or outlier removal. For instance, confidence intervals, standard deviation, etc., may be calculated with respect to reporting strength and/or robustness of each PPP rating 320 calculation.

In the illustrated example, PR computing device 102, responsive to request 110 for PPP rating 320, compares purchase amounts 316 and 318 of the first and second items containing similar or matching product, merchant, and/or category identifiers purchased during the requested input time period 118. For example, product category ID 308 of the first item data is matched with product category ID 310 of the second item data. Additionally or alternatively, product ID 312 of the first item data is matched with product ID 314 of the second item data. The purchase amounts of the matching data for the time range of input time period 118 are then compared. PR computing device 102 uses the comparison to calculate PPP rating 320.

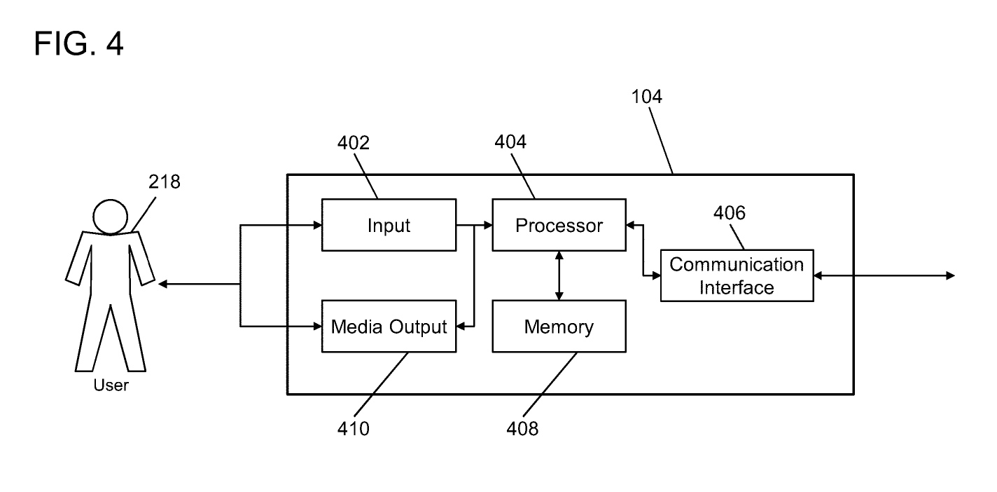

FIG. 4 illustrates an example configuration of the input user device 104 used in the PPP rating system 100 shown in FIG. 1. Input user device 104 may include, but is not limited to, a smart phone, a tablet, and a website. In the example embodiment, input user device 104 includes a processor 404 for executing instructions. In some embodiments, executable instructions are stored in a memory area 408. Processor 404 may include one or more processing units, for example, a multi-core configuration. Memory area 408 is any device allowing information such as executable instructions and/or written works to be stored and retrieved. Memory area 408 may include one or more computer readable media.

Input user device 104 also includes at least one media output component 410 for presenting information to user 218. Media output component 410 is any component capable of conveying information to user 218. In some embodiments, media output component 410 includes an output adapter such as a video adapter and/or an audio adapter. An output adapter is operatively coupled to processor 404 and operatively couplable to an output device such as a display device, a liquid crystal display (LCD), organic light emitting diode (OLED) display, or “electronic ink” display, or an audio output device, a speaker or headphones.

In some embodiments, input user device 104 includes an input device 402 for receiving input from user 218. Input device 402 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 410 and input device 402. Input user device 104 may also include a communication interface 406, which is communicatively countable to a remote device such as the digital account. Communication interface 406 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 408 are, for example, computer readable instructions for providing a user interface to user 218 via media output component 410 and, optionally, receiving and processing input from input device 402. A user interface may include, among other possibilities, a web browser and client application. Web browsers enable users, such as user 218, to display and interact with media and other information typically embedded on a web page or a website. A client application allows user 218 to interact with a server application from a server system.

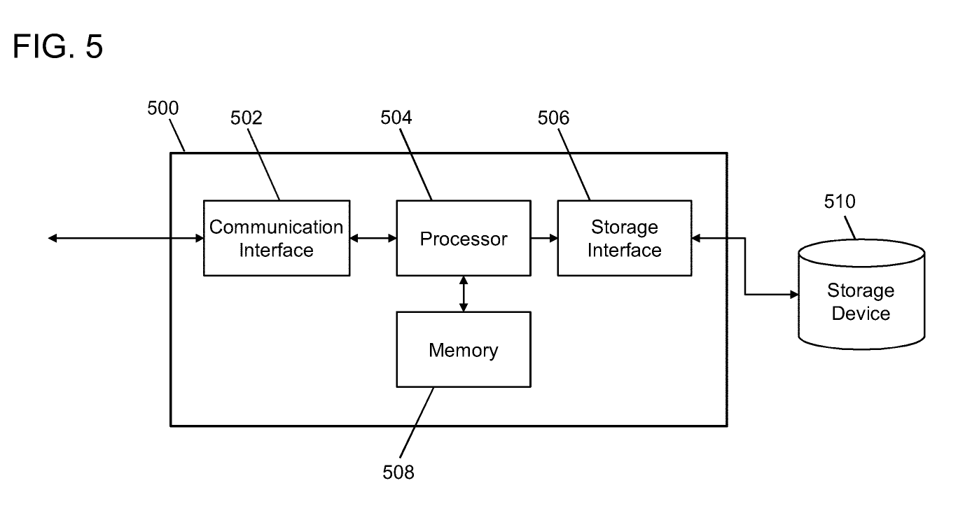

FIG. 5 illustrates a configuration of a database server 500 used in an alternative embodiment of PPP rating system 100 shown in FIG. 1. In this embodiment, database server 500 is a separate component and external to PR computing device 102. In some embodiments, PR computing device 102 is similar to or the same as database server 500.

Database server 500 may store transaction data 120. Database server 500 may be associated with a merchant store or a bank, and stores user account data, and sends, receives, and processes signals from various sources. Database server 500 includes a processor 504 for executing instructions. Instructions may be stored in a memory area 508, for example. Processor 504 may include one or more processing units (e.g., in a multi-core configuration) for executing instructions. The instructions may be executed within a variety of different operating systems on database server 500, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). Processor 504 is operatively coupled to a communication interface 502 such that database server 500 is capable of communicating with a remote device such as input user device 104, PR computing device 102, or another database server 500.

Processor 504 may also be operatively coupled to a storage device 510. Storage device 510 is any computer-operated hardware suitable for storing and/or retrieving data. In some embodiments, storage device 510 is integrated in database server 500. For example, database server 500 may include one or more hard disk drives as storage device 510. In other embodiments, storage device 510 is external to database server 500 and may be accessed by a plurality of databases 500. For example, storage device 510 may include multiple storage units such as hard disks or solid state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 506. Storage interface 506 is any component capable of providing processor 504 with access to storage device 510. Storage interface 506 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory area 508 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

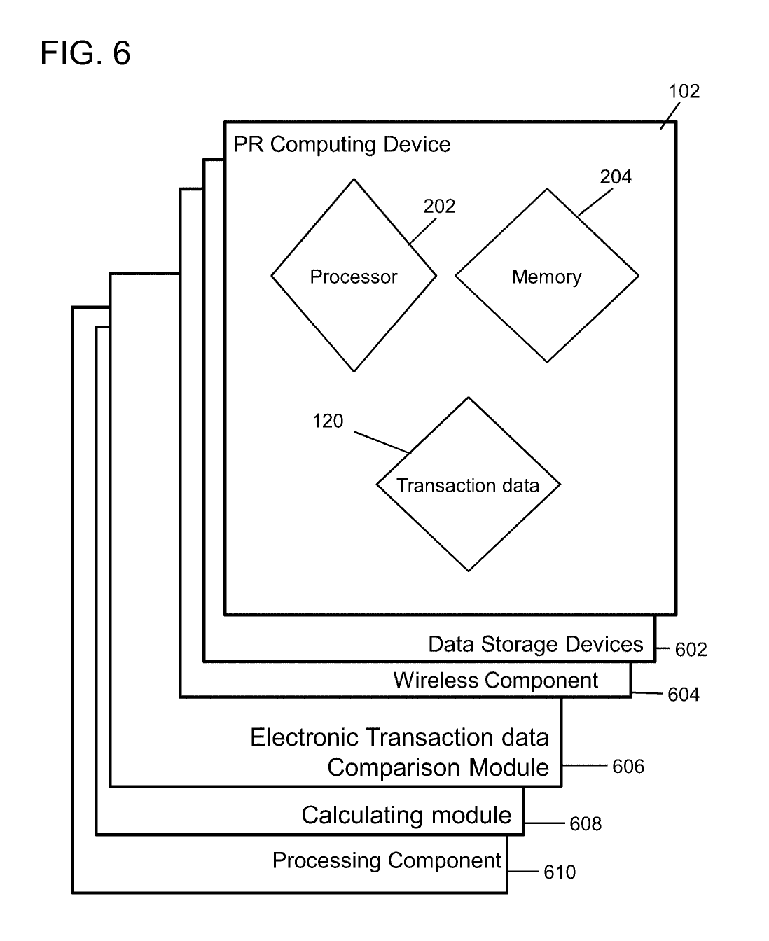

FIG. 6 is a diagram of components of one or more example PR computing devices 102 used in the PPP rating system 100 shown in FIG. 1. PR computing device 102 represents at least one PR computing device 102, which itself may include or be coupled to several separate components within the computing device which perform specific tasks described herein.

In the example embodiment, PR computing device 102 includes processor 202, memory 204, wherein memory 204 is configured to store transaction data 120 (described in detail above). As described above, memory 204 is further configured to store a plurality of rules used in calculating PPP rating 320. Processor 202 is a component or components within PR computing device 102, and is configured to communicate with at least one of memory 204, input user device 104, payment network 106, and/or third party entity 108.

PR computing device 102 further includes data storage devices 602, which may be any suitable device used for storing a plurality of digitized data. PR computing device 102 further includes a wireless component 604 for communicating wirelessly with at least one of memory 204, input user device 104, payment network 106, and/or third party entity 108. PR computing device 102 further includes an electronic transaction data comparison module 606 programed to compare, match, and contrast transaction data 120 between the first item data and the second item data. PR computing device 102 further includes a processing component 610 used to receive and communicate a plurality of digital data in connection with wireless component 604.

PR computing device 102 further includes a calculating module 608 for calculating PPP rating 320. As described above, in some embodiments, the PPP rating 320 calculation involves averaging and/or weighting data points (i.e., transaction amounts) for transactions associated with each region, and subsequently comparing the average (or weighted average) between regions to determine PPP rating 320. In other embodiments, PPP rating 320 calculation involves generating an array of ratios for each transaction match between the selected geographical regions. An average and/or weighted average of the ratios is used to determine PPP rating 320. In some embodiments, transaction data 120 is subject to various statistical data treatment methods such as significance testing, data point weighting, and/or outlier removal. For instance, confidence intervals, standard deviation, etc., may be calculated with respect to reporting strength and/or robustness of each PPP rating 320 calculation.

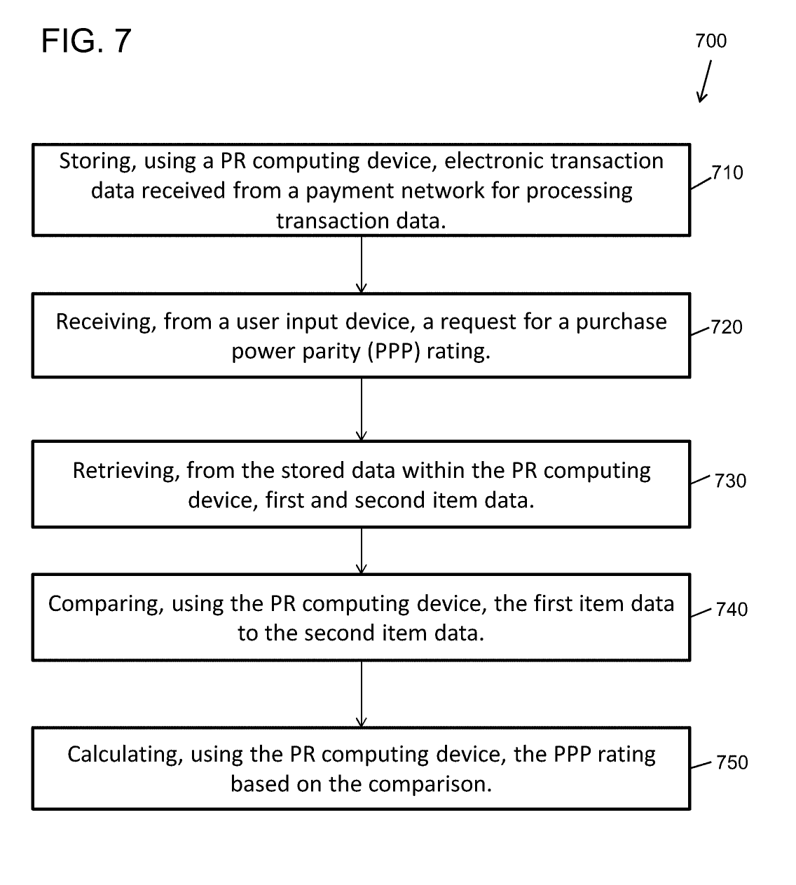

FIG. 7 shows a method 700 for calculating PPP rating 320 using PR computing device 102 shown in FIG. 1. PR computing device 102 stores 710, within at least one memory, electronic transaction data. As described above, transaction data includes a purchase amount, a purchase location, and item level data. The electronic transaction data retrieved from a payment network that processes electronic transaction data.

PR computing device 102 then receives 720, from the input user device, a request for a PPP rating. The request includes a first geographic region and a second geographic region. The request may also include an input time period from the input user device. After receiving the request, PR computing device retrieves 730, from the electronic transaction data stored within the at least one memory, first item data for the first geographic region during the input time period, and second item data for the second geographic region during the input time period. PR computing device then compares 740 the first item data to the second item data, and finally calculates 750 the PPP rating for the first geographic region based on the comparison.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A parity rating (PR) computing device for calculating a purchasing power parity (PPP) rating, the PR computing device comprising at least one processor in communication with at least one memory, said at least one processor configured to:
store, within the at least one memory, electronic transaction data including a purchase amount, a purchase location, and item level data, the electronic transaction data retrieved from a payment network that processes electronic transaction data;
receive, from an input user device, a request for a PPP rating that includes a first geographic region and a second geographic region;
receive an input time period from the input user device;
retrieve, from the electronic transaction data stored within the at least one memory, first item data for the first geographic region during the input time period, and second item data for the second geographic region during the input time period;
compare the first item data to the second item data; and
calculate the PPP rating for the first geographic region based on the comparison.

2. The device according to claim 1, wherein the item level data includes an item identifier that uniquely identifies the item, wherein the item includes a good or a service.

3. The device according to claim 2, wherein the item identifier identifies at least one of a manufacturer of the item, an item description, a material used to make the item, a size, a color, a packaging number of the item, and a warranty number associated with the item.

4. The device according to claim 3, wherein the item level data is stock keeping unit (SKU) data.

5. The device according to claim 1, wherein the item level data is received from a third party entity, wherein a third party entity includes any entity separate from the payment network that is capable of electronically providing item level data.

6. The device according to claim 1, wherein the item level data is retrieved from the payment network and is included within authorization messages transmitted over the payment network.

7. The device according to claim 1, wherein an input time period includes at least one of a day, a week, a month, and a year.

8. The device according to claim 1, wherein the request for the PPP rating is a request for a specific-type PPP rating, wherein the request further includes an single identifier corresponding to at least one of a product identifier, a product category identifier, a merchant identifier, and a merchant category identifier.

9. The device according to claim 1, wherein the request for the PPP rating is a request for a composite-type PPP rating, wherein the request further includes a plurality of identifiers, each identifier of the plurality is selected from at least one of a product identifier, a product category identifier, a merchant identifier, and a merchant category identifier.

10. A computer-implemented purchasing power parity (PPP) system for calculating a PPP rating comprising:
a parity rating (PR) computing device for calculating a purchasing power parity (PPP) rating, the PR computing device comprising at least one processor in communication with at least one memory, said at least one processor configured to:
store, within the at least one memory, electronic transaction data including a purchase amount, a purchase location, and item level data, the electronic transaction data retrieved from a payment network that processes electronic transaction data;
receive, from an input user device, a request for a PPP rating that includes a first geographic region and a second geographic region;
receive an input time period from the input user device;
retrieve, from the electronic transaction data stored within the at least one memory, first item data for the first geographic region during the input time period, and second item data for the second geographic region during the input time period;
compare the first item data to the second item data; and
calculate the PPP rating for the first geographic region based on the comparison.

11. The system according to claim 10, wherein the item level data includes an item identifier that uniquely identifies the item, wherein the item includes a good or a service.

12. The system according to claim 11, wherein the item identifier identifies at least one of a manufacturer of the item, an item description, a material used to make the item, a size, a color, a packaging number of the item, and a warranty number associated with the item.

13. The system according to claim 12, wherein the item level data is stock keeping unit (SKU) data.

14. The system according to claim 10, wherein the item level data is received from a third party entity, wherein a third party entity includes any entity separate from the payment network that is capable of storing item level data.

15. The system according to claim 10, wherein the item level data is retrieved from the payment network.

16. The system according to claim 10, wherein an input time period includes at least one of a day, a week, a month, and a year.

17. The system according to claim 10, wherein the request for the PPP rating is a request for a specific-type PPP rating, wherein the request further includes an single identifier corresponding to at least one of a product identifier, a product category identifier, a merchant identifier, and a merchant category identifier.

18. The system according to claim 10, wherein the request for the PPP rating is a request for a composite-type PPP rating, wherein the request further includes a plurality of identifiers, each identifier of the plurality is selected from at least one of a product identifier, a product category identifier, a merchant identifier, and a merchant category identifier.

19. A computer-implemented method for calculating a purchasing power parity (PPP) rating, said method implemented using a parity rating (PR) computing device including a processor in communication with a memory, said method comprising:
storing, within the memory, electronic transaction data including a purchase amount, a purchase location, and item level data, the electronic transaction data retrieved from a payment network that processes electronic transaction data;
receiving, from an input user device, a request for a PPP rating that includes a first geographic region and a second geographic region;
receiving an input time period from the input user device;
retrieving, from the electronic transaction data stored within the memory, first item data for the first geographic region during the input time period, and second item data for the second geographic region during the input time period;
comparing the first item data to the second item data; and
calculating the PPP rating for the first geographic region based on the comparison.

20. The method according to claim 19, wherein the item level data is received from at least one of a third party entity and the payment network.
